(19) United States
(12) Patent Application Publication
(10) Pub. No.: US 2014/0095975 A1
(43) Pub. Date: Apr. 3, 2014

(54) MULTIPLE ASPECT-RATIO DESIGN

(71) Applicants: Vinay Krishnaswamy, Woodinville, WA (US); Ravipal Soin, Kirkland, WA (US); William Hill, Carnation, WA (US)

(72) Inventors: Vinay Krishnaswamy, Woodinville, WA (US); Ravipal Soin, Kirkland, WA (US); William Hill, Carnation, WA (US)

(21) Appl. No.: 13/632,146

(22) Filed: Sep. 30, 2012

(51) Int. Cl. G06F 17/21

(52) U.S. Cl. CPC G06F 17/212
USPC 715/234

(57) ABSTRACT

The instant application discloses, among other things, techniques to allow publications suitable for varying aspect ratios and resolutions to be designed and stored, with an appropriate design selected at the time the publication is displayed.

### RELATED APPLICATIONS

This application claims priority to provisional application No. 61/525,156 filed Aug. 18, 2011 titled “Method and System for Collaborative Content Publishing and Consumption for Touch Sensitive Devices.”

### FIELD

This disclosure relates to Multiple Aspect-Ratio Design.

### BACKGROUND

The internet provides a foundation for people wishing to share pictures, text, multimedia, or other content with others.

It is often easy for an individual to post pictures or write a blog, although producing a well-designed product often requires special skills, which many users do not have.

High quality web design often requires different URLs for different aspect ratios and resolutions.

### SUMMARY

The instant application discloses, among other things, techniques to allow publications suitable for varying aspect ratios and resolutions to be designed and stored, with an appropriate design selected at the time the publication is displayed.

As an example, a person (publisher) may want to produce a web-based magazine about their children's soccer team. The magazine may be laid out with different designs for portrait and landscape viewing.

### BRIEF DESCRIPTION OF THE DRAWINGS

FIG. 1 is an example of a system on which Multiple Aspect-Ratio Design may be implemented.

FIG. 2 is an example of a publication designed for landscape-orientation viewing according to one embodiment.

FIG. 3 is an example of a publication designed for portrait-orientation viewing according to one embodiment.

FIG. 4 is a block diagram showing a relationship between content and stored layout configurations according to one embodiment.

FIG. 5 is a flow chart illustrating one possible embodiment of Multiple Aspect-Ratio Design.

FIG. 6 is a flow chart showing possible variations in reading configurations.

FIG. 7 illustrates a component diagram of a computing device according to one embodiment.

### DETAILED DESCRIPTION

A more particular description of certain embodiments of Multiple Aspect-Ratio Design may be had by references to the embodiments shown in the drawings that form a part of this specification, in which like numerals represent like objects.

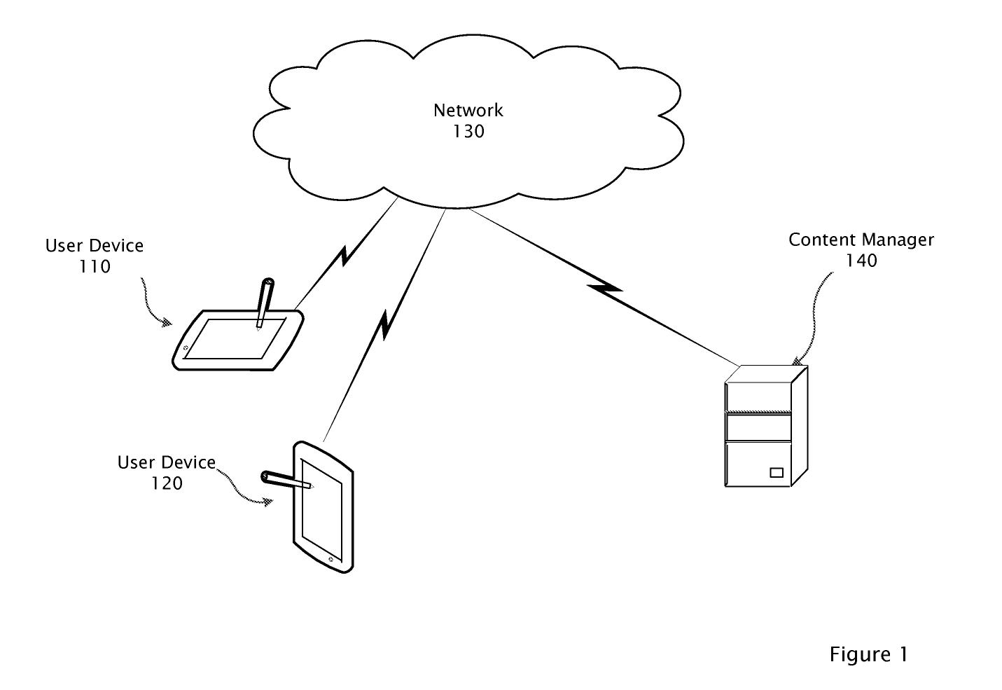

FIG. 1 is an example of a system on which Multiple Aspect-Ratio Design may be implemented. In this example, User Device 120 may be used to design a Multiple Aspect-Ratio Design and send it via Network 130 to Content Manager 140. For example, User Device 120 may be used to create a design for a publication when viewed with a portrait layout, and another design for the same publication when viewed with a landscape layout. These designs may include, for example, different fonts, different positions for text, images, or other design elements, or any other design changes desired. One having skill in the art will recognize that many different design changes may be used to provide high quality designs for each layout.

Network 130 may be a local area network, or it may include the Internet. Any type of communication link may be used, or all processing may occur on one device. Other types of data transfer may also be used, such as loading information from User Device 110 onto a portable drive and loading the information onto Content Manager 140.

Either User Device 110, User Device 120, or both may be used to design Multiple Aspect-Ratio Designs. These functions may be performed through the use of a web site, through a dedicated application, or through other ways of accessing Content Manager 140.

Content Manager 140 may include one or more computers, and may serve a number of roles, including, but not limited to, storing content and attributes, manipulating content and attributes, and serving content. For example, in one embodiment, Content Manager 140 may include a database with tables to store information about users, user devices, projects, articles, elements, layouts, layout definitions, and other data that may be relevant to Multiple Aspect-Ratio Design. By way of example, and not limitation, Content Manager may store layout and design information for a publication which has several different designs for viewing on several different orientations or resolutions.

One skilled in the art will recognize that many User Devices 110, 120 may be used during Multiple Aspect-Ratio Design, and that User Devices 110, 120 and Content Manger 140 may be of different designs and capabilities.

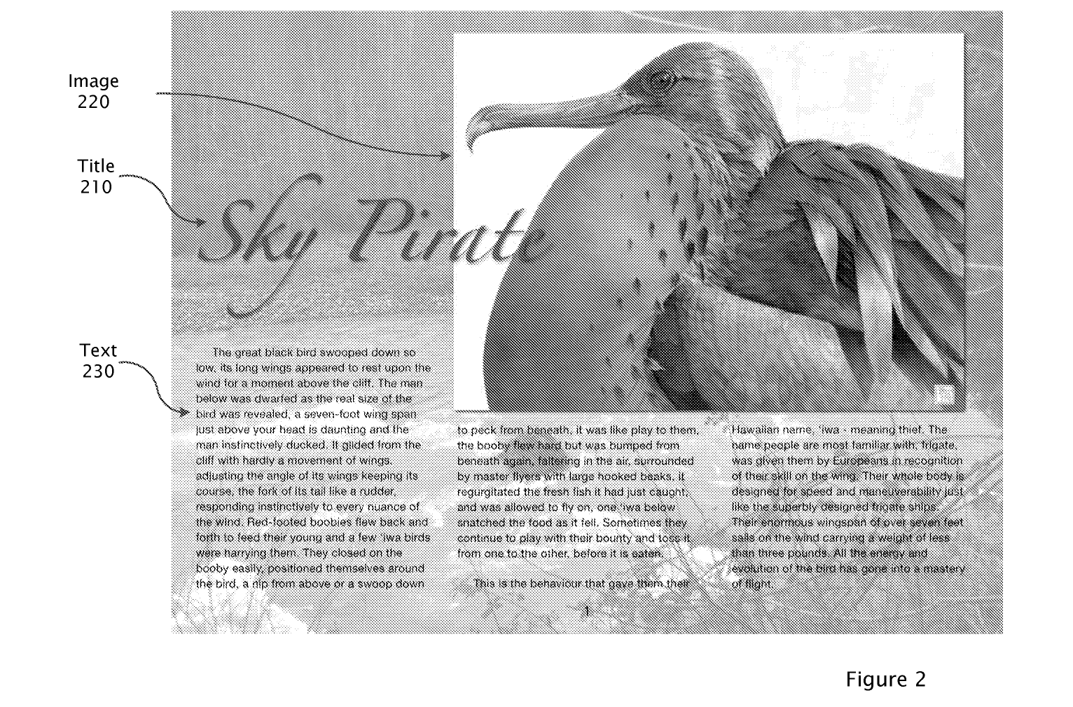

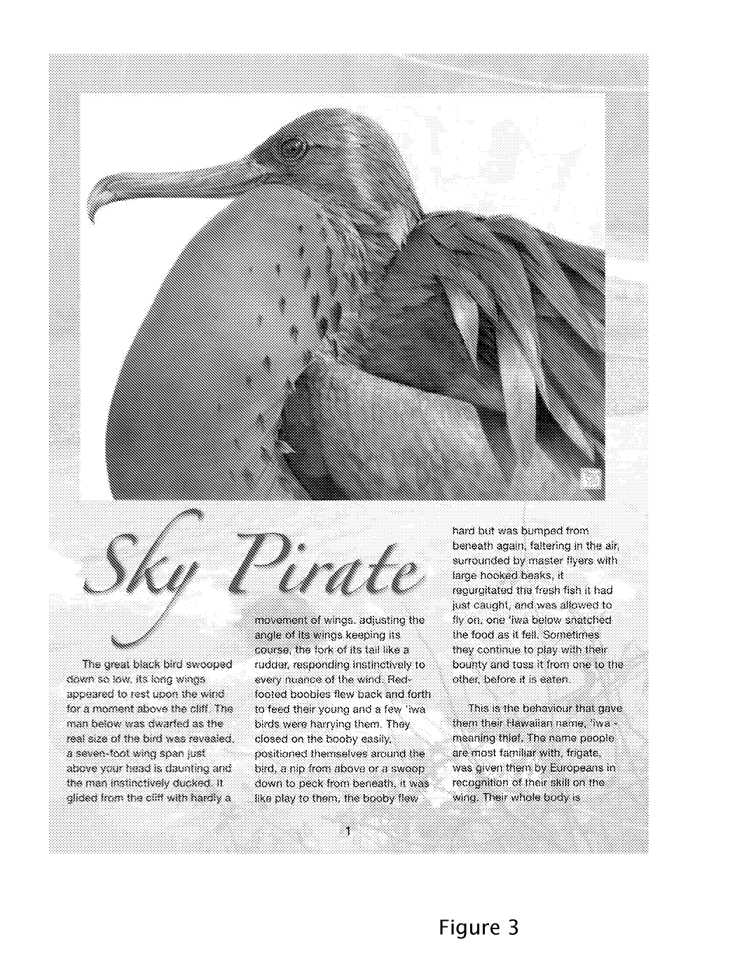

FIG. 2 and FIG. 3 show a publication with two different designs applied for landscape and portrait viewing respectively.

FIG. 2 is an example of a publication designed for landscape-orientation viewing. An Image 220 of a bird is in the upper right corner, while a Title 210 of the publication starts on the left and extends to over the image. The title has red text and the image of the bird has red coloring, so a shadow has been applied to the text to help it stand out against the red background. Three columns of Text 230 are displayed, with the first column starting above a bottom line of the image.

In one embodiment, a user publishing a publication may use a touch-sensitive tablet-style computer to layout Image 220, Title 210, and Text 230 while in a landscape mode. Once a desired design has been established, the user may switch to portrait mode, and create a design for that mode. The two designs may be very similar or very different, depending on the user's design goals.

In another embodiment, a user may design for one orientation and allow a design for another orientation to be designed automatically.

FIG. 3 is an example of a publication designed for portrait-orientation viewing. In this design, the same image, title, and text are used as in FIG. 2. But in this design, the title text is below the image of the bird, which fills most of the top available area. The three columns of text all start below the image, although the first two columns start lower to accommodate the title.

In addition to orientation-specific designs, designs may be made for special purposes. A design may be optimized for accessibility, for example, with high-contrast, limited color, or large fonts. A user may create a design to improve readability, to display data very efficiently, or meet other design goals. A design may also be automatically designed to meet a design goal.

One having skill in the art will recognize that there may be many differences in in layout and other design attributes desired between landscape and portrait layouts, as well as for devices with differing display resolutions and for other constraints that may be desired to place on designs.

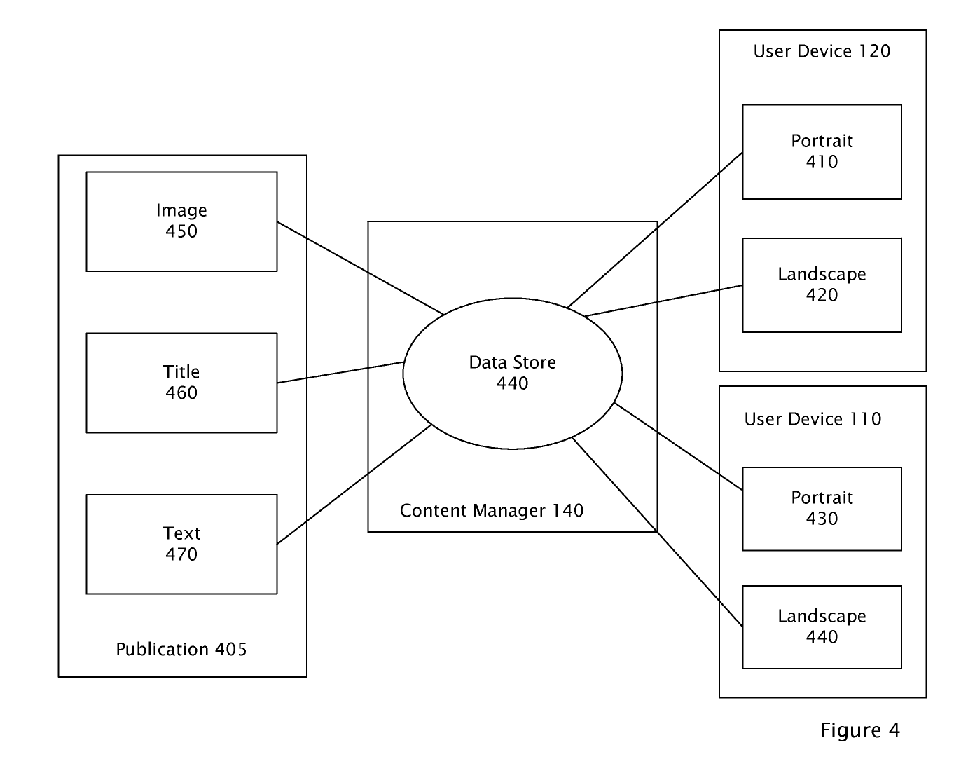

FIG. 4 is a block diagram showing a relationship between content and stored layout configurations. In this embodiment, User Device 120 may have a resolution of 2048 by 1536 pixels, and support Landscape Design 420 and Portrait Design 410 viewing modes. User Device 110 may have a resolution of 1136 by 640 pixels. The aspect ratios of these two devices differ as well as resolution, and it may be desirable to have different designs available for these variations.

Publication 405 may include items of content Image 450, Title 460, and Text 470. References to these items of content or copies of the items of content may be stored in Data Store 440, which may in one embodiment comprise a database table or set of tables. When Publication 405 is viewed on User Device 120, a design may be selected from Data Store 440 to match the orientation currently being used, Portrait Design 410, or Landscape Design 420. Similarly if User Device 110 is being used, a design corresponding to the resolution and orientation currently being used, Portrait Design 430, or Landscape Design 440, may be selected. In one embodiment, Data Store 440 may be deployed on Content Manager 140.

In the example shown, User Device 120 may obtain Publication 405 from Content Manager 140 with all appropriate designs; in this case a portrait and a landscape design. As user device 120 is rotated, the design used may change. In another embodiment, User Device 120 may receive a Portrait Design 410 and, when rotated, may receive Landscape Design 420.

One having skill in the art will recognize that many different techniques may be used to store and obtain various designs for different aspect ratios.

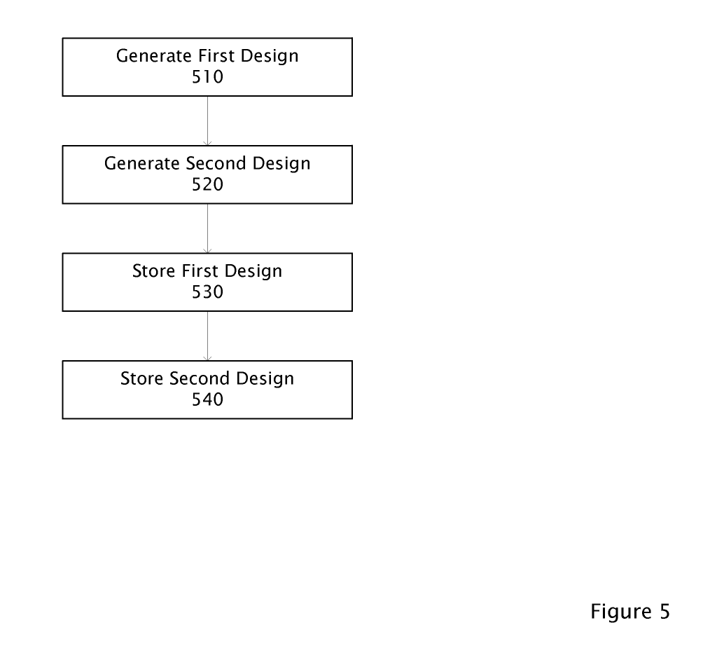

FIG. 5 is a flow chart illustrating one possible embodiment of Multiple Aspect-Ratio Design. A user may Generate First Design 510, which may be for a landscape orientation. The user may then Generate Second Design 520, which may be for a portrait orientation. The user may then Store First Design 530 and Store Second Design 540 to Content Manager 140.

In one embodiment, Generating Designs 510, 520 may be done manually, with the user formatting and placing various items of content using a design tool. In another embodiment, the user may choose a template and the content may be automatically formatted and laid out by a design tool. In some embodiments, templates may be grouped so that selecting a template for a landscape layout may provide another template for a portrait layout, or for other resolutions. In yet another embodiment, the content may be automatically laid out with some options available to the user to adjust a default format.

Further designs for other aspect ratios may also be generated and stored.

One having skill in the art will recognize that many different techniques may be used to format and lay out a design for one or more aspect ratios.

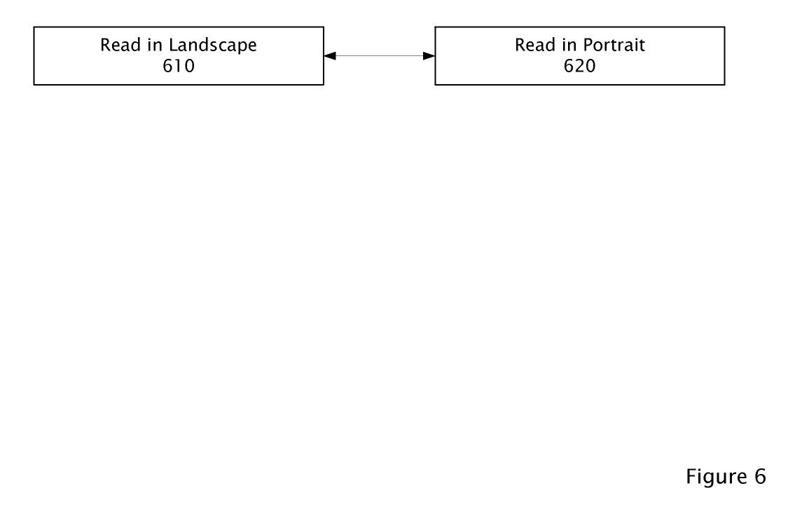

FIG. 6 is a flow chart showing possible variations in reading configurations. A user may start Reading in Landscape 610, and may then rotate a device and Read in Portrait 620. The user may switch between these two modes any number of times while reading a publication. Each time the user changes the orientation, an appropriate design may be displayed.

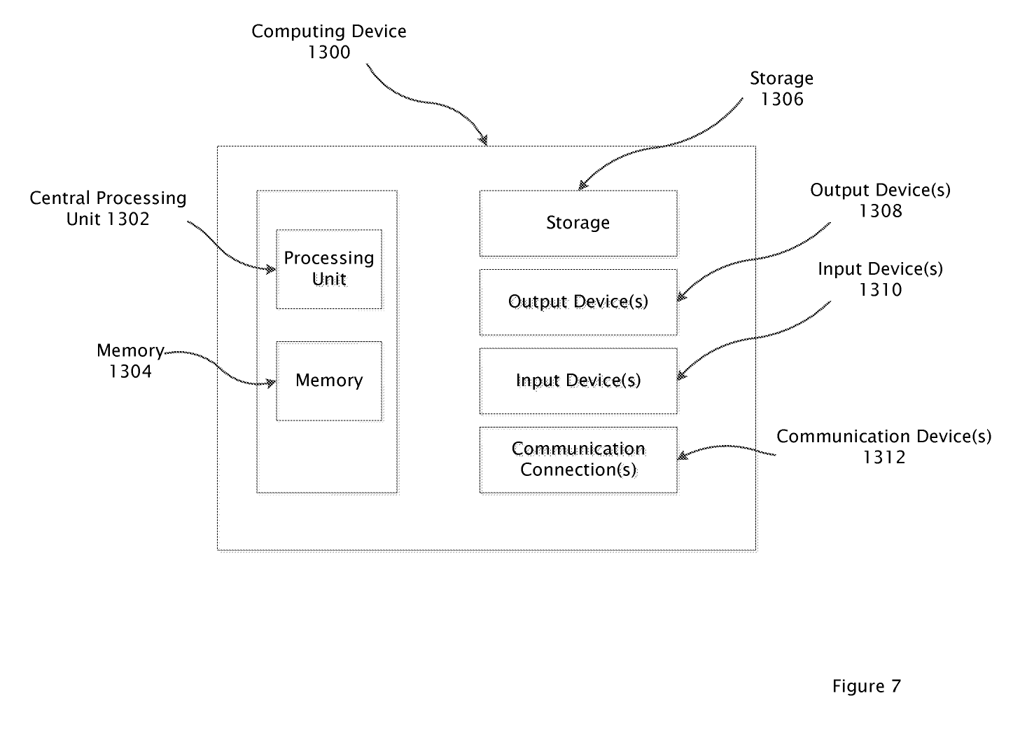

FIG. 7 illustrates a component diagram of a Computing Device according to one embodiment. The Computing Device (1300) can be utilized to implement one or more computing devices, computer processes, or software modules described herein, including, for example, but not limited to User Device 110, 120 or a Content Manager 140. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 120 or a Content Manager 140. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
a design receiving component configured to receive a design from a first user device; the design having attributes for a plurality of aspect ratios;
a data store component configured to store the received design; and
a data retrieval component configured to retrieve at least part of the received design upon request from a second user device.

2. The system of claim 1 wherein the attributes comprise a design for viewing in a landscape orientation and a design for viewing in a portrait orientation.

3. The system of claim 1 wherein the attributes comprise a design for viewing with a first device have a display resolution and a design for viewing with a second device having a second display resolution.

4. The system of claim 1 wherein the retrieval component retrieves part of the received design corresponding to an indicator of an aspect ratio associated with the request.

5. The system of claim 2 wherein the retrieval component retrieves the design for viewing in a landscape orientation and the design for viewing in a portrait orientation.

6. The system of claim 1 wherein the attributes comprise a design for viewing with high-contrast text.

7. A method, comprising:
receiving from a user device a first design for one or more pages of a publication for viewing on a display with a first resolution in a first orientation;
receiving from the user device a second design for one or more pages of the publication for viewing on a display with a second resolution in a second orientation; and
storing both the first and second design.

8. The method of claim 7, further comprising retrieving the first design and second design in response to a request from a user device.

9. A method, comprising:
designing, on a first user device, a first layout for a publication for viewing on a display with a first resolution in a first orientation;
designing, on the first user device, a second layout for the publication for viewing on a display with a second resolution in a second orientation;
saving the first layout and the second layout;
retrieving on a second user device, the first layout and second layout;
selecting a layout from the saved layouts based upon a resolution and an orientation of the second user device; and
displaying the publication using the selected layout.

10. The method of claim 9 wherein the first orientation is portrait and the second orientation is landscape.

11. The method of claim 9 further comprising:
designing, on the first user device, a third layout for the publication for viewing with high contrast colors.
